(19) United States
(12) Patent Application Publication
(10) Pub. No.: US 2023/0395045 A1
(43) Pub. Date: Dec. 7, 2023

(54) DRUM

(71) Applicant: Milton James Randall, Richmond (CA)

(72) Inventor: Milton James Randall, Richmond (CA)

(21) Appl. No.: 17/805,729

(22) Filed: Jun. 7, 2022

(51) Int. Cl. G10D 13/22; G10D 13/20; G10D 13/02

(52) U.S. Cl. CPC G10D 13/22; G10D 13/20; G10D 13/02

(57) ABSTRACT

A drum that is configured as various alternate styles of drums wherein the present invention is operable to provide an improved sound resonance during play thereof. The drum of the present invention includes a shell that has an upper end and a lower end. The shell includes an opening located and the upper end and lower end and the shell is hollow therebetween. The opening at the upper end of the shell includes a membrane stretched thereover. The shell includes at least one aperture formed in the outer wall thereof. The aperture formed in the outer wall is oval in shape in a preferred embodiment and is configured to provide improved airflow and sound resonance during the playing of the drum of the present invention. Alternate embodiments of the present invention include a shell having different quantities of apertures based on the size of the shell.

### FIELD OF THE INVENTION

The present invention relates generally to percussion instruments, more specifically but not by way of limitation, a drum that is configured to provide improved sound while in the standing position without the need of having to elevate the bottom of the drum.

### BACKGROUND

The drum is a member of the percussion group of musical instruments. Drums consist of at least one membrane called a drumhead or drum skin, that is stretched over a shell and struck, either directly with the player's hands, or with a percussion mallet, to produce sound. There is usually a resonant head on the underside of the drum. Other techniques have been used to cause drums to make sound, such as the thumb roll. Drums are the world's oldest and most ubiquitous musical instruments, and the basic design has remained virtually unchanged for thousands of years. Drums may be played individually, with the player using a single drum, and some drums such as the djembe are almost always played in this way. Others are normally played in a set of two or more, all played by the one player, such as bongo drums and timpani. The shell almost always has a circular opening over which the drumhead is stretched, but the shape of the remainder of the shell varies widely. In the Western musical tradition, the most usual shape is a cylinder, although timpani for example, use bowl-shaped shells. Other shapes include a frame design, truncated cones, goblet shaped and joined truncated cones. Drums with cylindrical shells can be open at one end as is the case with timbales or can have two drum heads, one head on each end. Single-headed drums typically consist of a skin stretched over an enclosed space, or over one of the ends of a hollow vessel. The shell forms a resonating chamber for the resulting sound. Drums with two heads can also have a set of wires, called snares, held across the bottom head, top head, or both heads, hence the name snare drum.

The sound of a drum depends on many variables including shape, shell size and thickness, shell materials, drumhead material, drumhead tension, drum position, location, and striking velocity and angle. Rebolo drums traditionally come from Brazil, where they're used in a style of music called pagode, Designed to be lightweight, with a powerful and warm bass tone, these drums are played rested sideways on the knee, with one hand striking the drum head and the other tapping on the wooden shell. A rebolo is a drum used in Brazilian samba ensembles.

Accordingly, there is a need for a drum that provides improved sound resonance while the drum is in the standing position wherein the drum of the present invention offers improved sound resonance

### SUMMARY OF THE INVENTION

It is the object of the present invention to provide a drum that is configured to provide improved sound resonance while the drum is oriented in the standing position wherein the drum of the present invention includes a shell.

Another object of the present invention is to provide a drum that is configured to provide improved sound resonance while in a standing position wherein the shell includes an upper end and a lower end.

A further object of the present invention is to provide a drum that is configured to provide improved sound resonance while the drum is oriented in the standing position wherein the upper end of the shell includes a first opening.

Still another object of the present invention is to provide a drum that is configured to provide improved sound resonance while in a standing position wherein the lower end of the shell includes a second opening.

An additional object of the present invention is to provide a drum that is configured to provide improved sound resonance while the drum is oriented in the standing position wherein the first opening has a membrane stretched thereover.

Yet a further object of the present invention is to provide a drum that is configured to provide improved sound resonance while in a standing position wherein the shell includes an outer wall.

Another object of the present invention is to a provide a drum that is configured to provide improved sound resonance while the drum is oriented in the standing position wherein the outer wall of the shell includes at least one aperture.

An additional object of the present invention is to provide a drum that is configured to provide improved sound resonance while in a standing position wherein the shell is provided in alternate shapes.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a perspective view of one embodiment of the present invention; and

FIG. 2 is a perspective view of an alternate embodiment of the present invention.

### DETAILED DESCRIPTION

Referring now to the drawings submitted herewith, wherein various elements depicted therein are not necessarily drawn to scale and wherein through the views and figures like elements are referenced with identical reference numerals, there is illustrated a drum 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

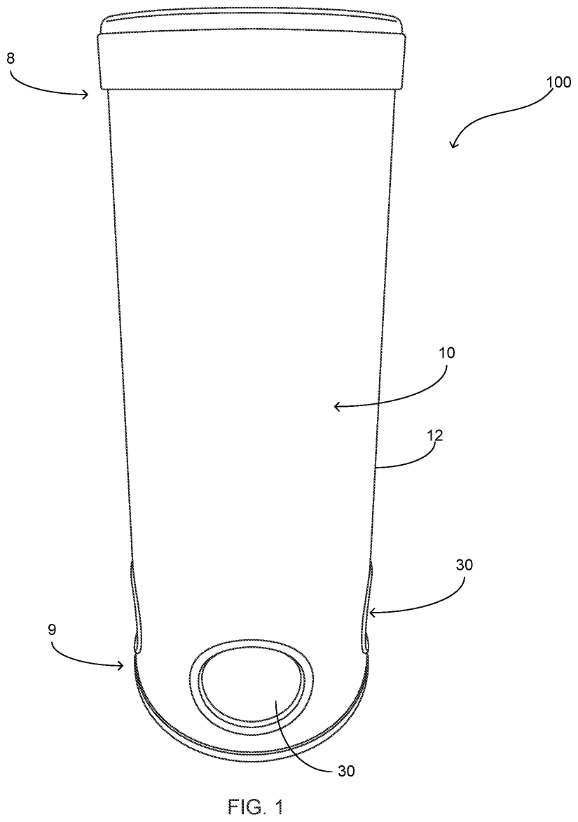

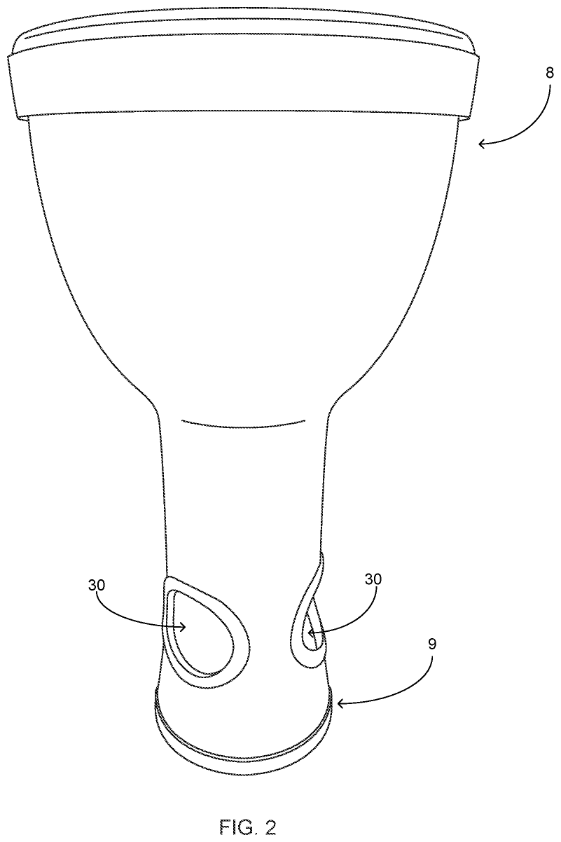

Now referring in particular to the FIGS. 1 and 2 submitted herewith, the drum 100 includes a shell 10. The shell 10 is formed with an outer wall 12 and has a hollow interior volume. The shell 10 of the drum 100 is manufactured from a rigid material such as but not limited to wood. It should be understood within the scope of the present invention that the shell 10 could be provided in alternate shapes and sizes. As is illustrated herein, the shell 10 can be a consistent diameter or have a varying diameter intermediate the first end 8 and second end 9. Furthermore, it should be understood within the scope of the present invention that the shell 10 could be provided in alternate heights.

The drum 100 includes a membrane 20 disposed over an opening proximate the first end 8. The membrane 20 is a conventional drum head that is manufactured from a plastic or mylar. The membrane 20 is secured to the outer surface of the shell utilizing suitable mechanical and/or chemical techniques. While not particularly illustrated herein, the shell 10 includes a second opening proximate the second end 9 of the shell 10.

Formed in the shell 10 utilizing suitable techniques are apertures 30. The apertures 30 are formed proximate the second end 9 of the shell 10. Drums that are manufactured to be a exemplary drum style such as but not limited to congo, djembe or tube as is the present invention have the second opening proximate the bottom. As such during playing thereof, a drummer will either tilt the body of the drum or place in a horizontal position in order to provide the desired sound resonance. The drum 100 of the present invention includes a shell 10 that has apertures 30 formed therein in order to allow more sound and resonance to be heard while the drum 100 is in its standing position. The apertures 30 formed in the outer wall 12 of the shell facilitate an unrestricted airflow and sound resonance without the need for lifting the shell 10. The apertures 30 are generally oval in shape in a preferred embodiment. It should be understood within the scope of the present invention that the apertures 30 could be provided in alternate shapes. Furthermore, it should be understood within the scope of the present invention that the apertures 30 could be provided in alternate locations and quantities. By way of example but not limitation, the shell 10 could have as few as one aperture 30. Alternatively, the shell 10 could have four apertures 30 wherein the four apertures 30 are equidistantly distributed across the circumference of the shell 10. Lastly, it is contemplated within the scope of the present invention that the shell 10 could have as many as six apertures 30. It should be understood within the scope of the present invention that the size and quantity of the apertures 30 are dependent upon the size of the shell 10 wherein a larger shell 10 would be provided with a higher quantity of apertures 30. It should be further understood within the scope of the present invention that the drum 100 could be manufactured as any style of drum.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding description is, therefore, not intended to be limited to the specific forms set forth herein, but on the contrary, it is intended to cover such alternatives, modifications, and equivalents, as can be reasonably included within the spirit and scope of the invention.

What is claimed is:

1. A drum configured to provide improved airflow and sound resonance during play thereof wherein the drum comprises:
a shell, said shell being manufactured from a rigid material, said shell having an upper end and a lower end, said shell being hollow between said upper end and said lower end, said shell having an opening at said upper end, said shell having an opening at said lower end;
a membrane, said membrane being stretched across said opening at said upper end; and
at least one aperture, said at least one aperture being formed in said shell, said at least one aperture being proximate said lower end.

2. The drum configured to provide improved airflow and sound resonance as recited in claim 1, wherein said at least one aperture is oval in shape.

3. The drum configured to provide improved airflow and sound resonance as recited in claim 2, wherein the drum is a rebolo style drum.

4. A drum configured to provide improved airflow and sound resonance during play thereof wherein the drum comprises:
a shell, said shell being manufactured from a rigid material, said shell having an outer wall, said shell having an upper end and a lower end, said shell being hollow between said upper end and said lower end, said shell having an opening at said upper end, said shell having an opening at said lower end;
a membrane, said membrane being stretched across said opening at said upper end; and
a plurality of apertures, said plurality of apertures being formed in said outer wall of said shell, said plurality of apertures being proximate said lower end.

5. The drum configured to provide improved airflow and sound resonance as recited in claim 4, wherein said plurality of apertures are circumferentially disposed on said outer wall of said shell and wherein said plurality of apertures are equidistantly spaced around said shell.
